(19) United States
(12) Patent Application Publication
(10) Pub. No.: US 2013/0284330 A1
(43) Pub. Date: Oct. 31, 2013

(54) PNEUMATIC TIRE

(71) Applicant: TOYO TIRE & RUBBER CO., LTD., Osaka (JP)

(72) Inventor: Kunihiko Nagai, Osaka-shi (JP)

(73) Assignee: TOYO TIRE & RUBBER CO., LTD., Osaka (JP)

(21) Appl. No.: 13/861,049

(22) Filed: Apr. 11, 2013

(30) Foreign Application Priority Data
Apr. 25, 2012 (JP) 2012-099919

(51) Int. Cl. B60C 19/08

(52) U.S. Cl. CPC B60C 19/08
USPC 152/152.1

(57) ABSTRACT

A pneumatic tire has a carcass ply, a tread rubber, a side wall rubber and a rim strip rubber. A topping rubber of the carcass ply and the side wall rubber are formed by a non-conductive rubber. The rim strip rubber is formed by a conductive rubber. A height of an outer end of the rim strip rubber is equal to or more than 50% of a tire cross section height. JIS A hardness of the side wall rubber is equal to or more than 59 degrees. A side conductive layer formed by the conductive rubber is provided between the side wall rubber and the carcass ply. The side conductive layer is connected to the tread rubber and the rim strip rubber. A conductive route reaching the outer end of the side conductive layer from a ground-contacting surface is constructed in the tread rubber.

### BACKGROUND OF THE INVENTION

1. Field of the Invention

The present invention relates to a pneumatic tire which can discharge static electricity generated in a vehicle body or a tire to a road surface.

2. Description of the Related Art

Recently, there have been proposed a pneumatic tire including a tread rubber blended with silica at a high ratio in order to reduce the rolling resistance that largely affects the fuel consumption of a vehicle and to increase braking performance (WET braking performance) on a wet road surface. However, compared to a tread rubber blended with carbon black at a high ratio, the electric resistance of such tread rubber is high, and accordingly, static charge generated on a vehicle body or the tire is prevented from being released to the road surface. As a result, problems like radio noises tend to occur.

There has been developed a pneumatic tire structured such that a conductive route is constructed by partially arranging a conductive rubber having a carbon black blended therein in a tread rubber made of a non-conductive rubber having a silica or the like blended therein, thereby achieving a conductive performance. For example, Patent Documents 1 and 2 describe a pneumatic tire in which a conductive rubber is embedded in a tread rubber formed by a non-conductive rubber, thereby constructing a conductive route.

In order to enhance an effect of reducing a rolling resistance, it is preferable to use the non-conductive rubber in a topping rubber of a carcass ply and a side wall rubber, in addition to the tread rubber. In this case, it is necessary to construct the conductive route in a side portion of the tire. For example, Patent Documents 3 and 4 describe a pneumatic tire in which a conductive rubber is provided between a carcass ply and a side wall rubber, and a conductive route is constructed via the conductive rubber.

Further, in recent years, there is tendency for promoting weight saving of the tire, however, if a rigidity of the tire deteriorates too much in connection with the weight saving, reduction of a steering stability performance and deterioration of a ride comfort performance due to a damping property are caused. Accordingly, in order to achieve a good steering stability performance and a good ride comfort performance, a structure which can secure a rigidity of the side portion of the tire is desired.

### PRIOR ART DOCUMENTS

Patent Document 1: Japanese Unexamined Patent Publication No. 2010-115935
Patent Document 2: Japanese Unexamined Patent Publication No. 2009-126291
Patent Document 3: Japanese Unexamined Patent Publication No. 2007-8269
Patent Document 4: Japanese Unexamined Patent Publication No. 2006-143208

### SUMMARY OF THE INVENTION

The present invention is made by taking the actual condition mentioned above into consideration, and an object of the present invention is to provide a pneumatic tire which can secure a rigidity of a side portion of the tire so as to achieve a good steering stability performance and a good ride comfort performance while having a conductive performance.

The object can be achieved by the following present invention. That is, the present invention provides a pneumatic tire comprising a carcass ply reaching a bead portion via a side wall portion from a tread portion, a tread rubber provided in an outer side of the carcass ply in the tread portion, a side wall rubber provided in an outer side of the carcass ply in the side wall portion, and a rim strip rubber provided in the outer side of the carcass ply in the bead portion and being contactable with a rim, wherein a topping rubber of the carcass ply and the side wall rubber are formed by a non-conductive rubber, and the rim strip rubber is formed by a conductive rubber, a height of an outer end of the rim strip rubber arranged in the outer side of the carcass ply is equal to or more than 50% of a tire cross section height based on a bead base line, JIS A hardness of the side wall rubber is equal to or more than 59 degrees, a side conductive layer having a smaller thickness than the side wall rubber and formed by the conductive rubber is provided between the side wall rubber and the carcass ply, an outer end of the side conductive layer is connected to the tread rubber, and an inner end of the side conductive layer is connected to the rim strip rubber, and a conductive route reaching the outer end of the side conductive layer from a ground-contacting surface is constructed in the tread rubber.

According to the pneumatic tire of the present invention, the conductor route is constructed in the side portion of the tire by the rim strip rubber and the side conductive layer, and a static electricity can be discharged to a road surface through the conductive route via them. Further, since the outer end of the rim strip rubber is arranged at the high position and the rubber hardness of the side wall rubber is set higher, it is possible to secure a rigidity of the side portion of the tire, thereby achieving a good steering stability performance and a good ride comfort performance.

It is preferable that a portion constructing at least the ground-contacting surface is formed the non-conductive rubber, and a tread conductive layer continuously extending from one end exposed to the ground-contacting surface to the other end reaching the outer end of the side conductive layer and formed by the conductive rubber is embedded, in the tread rubber.

Since the portion constructing the ground-contacting surface of the tread rubber is formed by the non-conductive rubber, an effect of improving a wet braking performance can be obtained in addition to an effect of reducing a rolling resistance. All the same time, since the tread conductive layer having one end exposed to the ground-contacting surface and the other end reaching the outer end of the side conductive layer is embedded, the conductive route can be constructed by the tread conductive layer with the side conductive layer, thereby achieving the conductive performance.

It is preferable that a length in a tire diametrical direction from the outer end of the side conductive layer to the inner end is in a range between 30 and 55% of the tire cross section height. Since the length is equal to or more than 30%, the length of the side conductive layer can be appropriately secured, thereby being useful for connecting to both the tread rubber and the rim strip rubber. Further, since the length is equal to or less than 55%, a weight saving of the tire is promoted while avoiding the side conductive layer from becoming to long, thereby effectively reducing the rolling resistance by preventing the conductive rubber from unnecessarily increasing.

It is preferable that a height of the inner end of the side conductive layer is equal to or more than 55% of the tire cross section height based on the bead base line. According to the structure mentioned above, the weight saving of the tire is promoted while avoiding the side conductive layer becoming too long, and it is possible to effectively reduce the rolling resistance by preventing the conductive rubber from unnecessarily increasing.

It is permissible that the side conductive layer is formed by a conductive rubber which is extruded together with the site wall rubber. In this case, it is possible to simply suppress an increase of the thickness of the side portion of the tire, which is advantageous for saving weight of the tire. Further, since the side conductive layer can be integrally handled with the side wall rubber at a time of forming the tire, a working efficiency can be enhanced.

It is permissible that the side conductive layer is formed by a rubber tape which is an independent member from the side wall rubber. In this case, since the rubber tape having the predetermined thickness is used, and it is easily to stably supply the rubber tape, this is preferable in practical.

### BRIEF DESCRIPTION OF THE DRAWINGS

FIG. 1 is a half cross sectional view of a tire meridian showing an example of a pneumatic tire in accordance with the present invention.

FIG. 2 is a cross sectional view of a side wall rubber which is extruded together with a conductive rubber that is to be a side conductive layer.

### DETAILED DESCRIPTION OF THE PREFERRED EMBODIMENTS

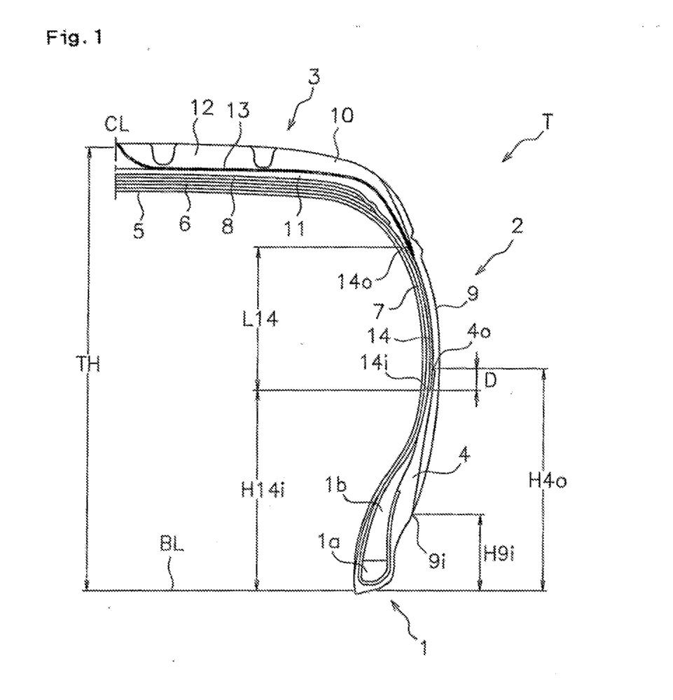

An embodiment of the present invention will be explained with reference to the drawings. A pneumatic tire T shown in FIG. 1 includes a pair of bead portions 1, side wall portions 2 extending from the bead portions 1 to outer side in a tire diametrical direction, a tread portion 3 connected to outer ends in a tire diametrical direction of the side wall portions 2. In the bead portion 1, an annular bead core 1a which is composed of a bundle of steel wires or the like, sheathed with rubber is embedded, and a bead filler 1b made of hard rubber is disposed to outer side in a tire diametrical direction of the bead core 1a.

Further, the tire T is provided with a carcass ply 7 which reaches the bead portion 1 from the tread portion 3 via the side wall portion 2, a tread rubber 10 which is provided in an outer side of the carcass ply 7 in the tread portion 3, a side wall rubber 9 which is provided in the outer side of the carcass ply 7 in the side wall portion 2, and a rim strip rubber 4 which is provided in the outer side of the carcass ply 7 in the bead portion 1 and can come into contact with a rim (not shown).

The carcass ply 7 is formed as a toroidal shape as a whole, and is rolled up its end portion in such a manner as to pinch the bead core 1a. The carcass ply 7 is formed by coating ply cords arranged in a direction which is approximately orthogonal to a tire equator CL with a topping rubber. The topping rubber of the carcass ply 7 is formed by a non-conductive rubber. An inner side of the carcass ply 7 is provided with an inner liner rubber 5 for retaining a pneumatic pressure.

An inner side in a tire diametrical direction of the tread rubber 10 is provided with a belt 6 which is constructed by a plurality of belt plies, and a belt reinforcing material 8 which is arranged in an outer side in the tire diametrical direction of the belt 6. Each of the belt plies is formed by coating the belt cords aligned in a direction which is inclined to a tire circumferential direction with the topping rubber, and is laminated in such a manner that the belt cords intersect in an inverted direction with each other between the plies. The belt reinforcing material 8 is formed by coating reinforcing cords substantially extending in the tire circumferential direction with the topping rubber.

The side wall rubber 9 constructs a tire outer surface in the side wall portion 2, and comes into contact with the rim strip rubber 4 from an outer side in a tire width direction. The side wall rubber 9 is formed by a non-conductive rubber, and a rubber hardness (JIS A hardness measured at 25° C. according to a durometer hardness test (type A) of JIS K6253, the same shall apply, hereinafter) thereof is equal to or more than 59 degrees. The tire T employs a so-called side-on-tread structure in which an end portion of the side wall rubber 9 is mounted on an end portion of the tread rubber 10, however, the structure of the tire is not limited to this.

The rim strip rubber 4 constructs a tire outer surface in the bead portion 1. A height H4o of an outer end 4o of the rim strip rubber 4 arranged in the outer side of the carcass ply 7 is set to be equal to or more than 50% of a tire cross section height TH based on a bead base line BL. In the light of prevention of deterioration of a ride, comfort performance due to an absorbability, it is preferable that the height H4o is equal to or less than 55% of the tire cross section height TH. The rim strip rubber 4 is formed by a conductive rubber. The rim strip rubber 4 is harder than the side wall rubber 5, and a rubber hardness difference thereof is, for example, equal to or more than 10 degrees.

A side conductive layer 14 having a smaller thickness than the side wall rubber 9 and formed by the conductive rubber is provided between the side wall rubber 9 and the carcass ply 7. An outer end 14o of the side conductive layer 14 is connected to the tread rubber 10, and an inner end 14i of the side conductive layer 14 is connected to the outer end 4o of the rim strip rubber 4. A conductive route reaching the outer end 14o of the side conductive layer 14 from the ground-contacting surface is constructed in the tread rubber 10. A static electricity generated in a vehicle body or the like is discharged to a road surface from the rim through the rim strip rubber 4, the side conductive layer 14 and the conductive route constructed in the tread rubber 10.

The tread rubber 10 has a cap layer 12 which constructs the ground-contacting surface, a base layer 11 which is provided in an inner side in the tire diametrical direction of the cap layer 12, and a tread conductive layer 13 which is embedded in the tread rubber 10. In order to obtain an effect of improving a wet braking performance, it is necessary to at least form the cap layer 12 by the non-conductive rubber, and both the cap layer 12 and the base layer 11 are formed by the non-conductive rubber in the present embodiment. The tread conductive layer 13 extends continuously from one end which is exposed to the ground-contacting surface to the other end which reaches the outer end 14o of the side conductive layer 14, and is formed by the conductive rubber.

As long as a necessary conductive route is constructed in the tread rubber 10, a shape of the tread conductive layer is not particularly limited. In the present embodiment, there is shown an example in which the outer end 14o of the side conductive layer 14 is connected to a bottom surface of the tread rubber 10, however, the outer end 14o may be connected to a side surface of the tread rubber 10 by interposing the side conductive layer 14 between the side wall rubber 9 and the tread rubber 10. In this case, the other end of the tread conductive layer may be exposed in the side surface of the tread rubber 10. Further, a whole of the tread rubber 10 may be formed by the conductive rubber.

The conductive rubber means a rubber in which a volume resistivity at a room temperature (20° C.) is less than 10⁸ Ω·cm, and is produced, for example, by blending a carbon black as a reinforcing agent at a high rate in a raw material rubber. The carbon black is blended, for example, by 30 to 100 parts by weight in relation to 100 parts by weight of a rubber component. The conductive rubber can be obtained by blending a known conductivity applying material such as a carbon including a carbon fiber, a graphite and the like, or a metal including a metal powder, a metal oxide, a metal flake, a metal fiber and the like other than the carbon black.

The non-conductive rubber means a rubber in which a volume resistivity at a room temperature (20° C.) is equal to or more than 10⁸ Ω·cm, and is produced, for example, by blending a silica as a reinforcing agent at a high rate in a raw material rubber. The silica is blended, for example, by 30 to 100 parts by weight in relation to 100 parts by weight of a rubber component. As the silica, a wet silica may be preferably employed, however, any general-purpose reinforcing material may be used without being limited. The non-conductive rubber may be produced by blending a burned clay or a hard clay, a calcium carbonate or the like other than the silica group such as a precipitated silica, an anhydrous silic acid or the like.

Further, in the non-conductive rubber forming the topping rubber of the carcass ply 7, it is preferable to use a material which does not include any silica or is blended with the silica at a low rate, and has a highly dispersed carbon black as a main component, as a reinforcing agent blended in the raw material rubber. Accordingly, it is possible to improve a rigidity of the side portion of the tire, thereby enhancing an effect of improving a steering stability performance, while suppressing an increase of the rolling resistance.

As for the raw material rubber mentioned above, the following are exemplified; i.e., natural rubber, styrene-butadiene rubber (SBR), butadiene rubber (BR), isoprene rubber (IR), butyl rubber (IIR) and the like. These materials may be used alone or in combination. The above raw rubber is appropriately blended with a curing agent, a cure accelerator, a plasticizer, an antioxidant and the like.

In the tire T, since the outer end 4o of the rim strip rubber 4 is arranged at the high position, and the rubber hardness of the side wall rubber 9 is set higher, it is possible to secure the rigidity of the side portion of the tire, thereby achieving a good steering stability performance and a good ride comfort performance. A rubber hardness of the side wall rubber 9 is equal to or higher than 59 degrees as mentioned above, however, is preferably set to 60 to 65 degrees. In the light of improvement of a uniformity of the tire T, it is preferable that the side conductive layer 14 is provided as an annular shape continuously in the tire circumferential direction.

A length L14 in the tire diametrical direction from the outer end 14o of the side conductive layer 14 to the inner end 14i is preferably in a range between 30 and 55% of the tire cross section height TH, and is more preferably in a range between 35 and 50% thereof. Further, in the light of prevention of the side conductive layer 14 from becoming unnecessarily longer, a height H14i of the inner end 14i is preferably set to be equal to or more than 55% of the tire cross section height TH based on a bead base line BL, and is more preferably set to be equal to or more than 70%. A rubber harness of the side conductive layer 14 is preferably equal to or less than 58 degrees, and is more preferably set to 55 to 57 degrees.

The inner end 14i of the side conductive layer 14 is arranged between the carcass ply 7 and the rim strip rubber 4. In the light of secure connection between the side conductive layer 14 and the rim strip rubber 4, it is preferable that an overlapping margin D between the rim strip rubber 4 and the side conductive layer 14 is equal to or more than 10 mm. Further, in the light of prevention of the side conductive layer 14 from becoming unnecessarily longer, the overlapping margin D is preferably equal to or less than 15 mm. A height H9i of an inner end 9i of the side wall rubber 9 is set, for example, to 10 to 20% of the tire cross section height TH based on the head base line BL.

In the present embodiment, there is shown an example in which the side conductive layer 14 is formed by a rubber tape which is an independent member from the side wall rubber 9. Namely, the tire T is formed by attaching the rubber tape to the carcass ply 7, and attaching the other tire constituting rubber members such as the side wall rubber 9 and the rim strip rubber 4. In order to achieve red of the rolling resistance by promoting the weight saving of the tire T, the thickness of the side conductive layer 14 is preferably equal to or less than 0.6 mm, and more preferably equal to or less than 0.3 mm.

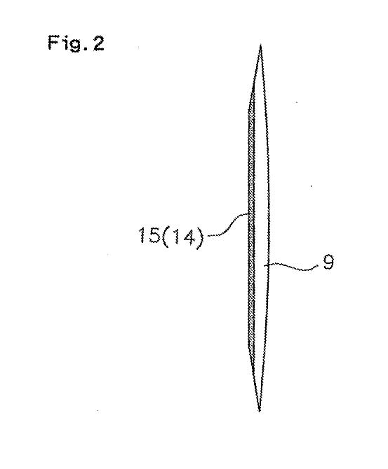

In the present invention, the side conductive layer 14 may be formed by a conductive rubber which is extruded together with the side wall rubber 9. In this case, the tire T is formed by using the side wall rubber 9 which is extruded together with the conductive rubber 15 that is to be the side conductive layer 14, as exemplified in FIG. 2. An inner end of the side conductive layer 14 formed thereby is arranged between the side wall rubber 9 and the rim strip rubber 4.

It is possible to specify in a tire after a cure treatment, whether the side conductive layer 14 is formed by the rubber tape which is the independent member from the side wall rubber 9, or the side conductive layer 14 is extruded together with the side wall rubber 9. It is possible to discriminate based on a nature of a rubber interface which is observed thinly in a cross section thereof, for example, by cutting the tire with a sharp cutting tool.

The side conductive layer 14 may be provided in both sides in a tire width direction, however, is preferably provided only in one side in order to achieve the weight saying of the tire. In this case, in the light of enhancing the steering stability performance at a time of cornering, it is further preferable to arrange the side conductive layer 14 in an outer side of a vehicle. Specification of orientation for installing to the vehicle is carried out, for example, by attaching to the side wall portion 2 a display indicating an outer side of the vehicle or an inner side of the vehicle.

The present invention is not limited to the embodiment mentioned above, but can be variously improved or changed within a scope which does not deflect from the scope of the present invention. For example, in the embodiment mentioned above, there is shown the example in which the side-on-tread (SWOT) is employed as the tread structure. Alternatively, however, a so-called tread-on-side (TOS) in which the end portion of the tread rubber is mounted to the end portion of the side wall rubber may be employed.

### EXAMPLES

An example which concretely shows the structure and effect of the present invention will be explained. An evaluation of each of performances is executed as follows.

(1) Electric Resistance (Conductive Performance)

An electric resistance value was measured by applying a predetermined load to the tire installed to the rim, and applying an applied voltage (500V) to a metal plate with which the tire grounds from the shaft supporting the rim.

(2) Rolling Resistance

The rolling resistance was measured according to the International Standard ISO28580 (JIS D4234), and was evaluated based on an inverse number thereof. The rolling resistance was evaluated based on an index number by setting a result of a comparative example 1 to 100, and the greater numerical value indicates the more excellent rolling resistance.

(3) Steering Stability Performance

The tire was installed to the actual car and was set to a pneumatic pressure which was designated for the vehicle, and the steering stability performance was evaluated based on a subjective test of a driver by executing a straight traveling and a cornering traveling. The steering stability performance was evaluated based on an index number by setting a result of a comparative example 1 to 100, and the greater numerical value indicates the more excellent steering stability performance.

(4) Ride Comfort Performance (Damping Feeling)

The tire was installed to the actual car and was set to have the pneumatic pressure which was designated for the vehicle, and the ride comfort performance was evaluated based on a subjective test of the driver by executing the traveling of climbing over a projection provided on the road surface. The ride comfort performance was evaluated based on an index number by setting a result of the comparative example 1 to 100, and the greater numerical value indicates the more excellent ride comfort performance.

A size of the tire provided for evaluation is 195/65R15, and a tire structure and a rubber compounding are in common in each of the examples except items shown in Table 1. “Non-conductive” in Table 1 means formation by non-conductive rubber, and “conductive” means formation by conductive, rubber. A rubber hardness of the rim strip rubber in each of the examples was set to 69 degrees. Results of evaluation are shown in Table 2.

TABLE 1

| | | Com- | Com- | Com- | Com- | Com- | | | | | | |
|---|---|---|---|---|---|---|---|---|---|---|---|---|
| | | parative | parative | parative | parative | parative | Working | Working | Working | Working | Working | Working |
| | | Example 1 | Example 2 | Example 3 | Example 4 | Example 5 | Example 1 | Example 2 | Example 3 | Example 4 | Example 5 | Example 6 |
| Tread structure | | SWOT | TOS | SWOT | SWOT | SWOT | SWOT | SWOT | SWOT | SWOT | SWOT | SWOT |
| Cap portion | | Non- | Non- | Non- | Non- | Non- | Non- | Non- | Non- | Non- | Con- | Non- |
| | | conductive | conductive | conductive | conductive | conductive | conductive | conductive | conductive | conductive | ductive | conductive |
| Base portion | | Non- | Non- | Non- | Non- | Non- | Non- | Non- | Non- | Non- | Non- | Non- |
| | | conductive | conductive | conductive | conductive | conductive | conductive | conductive | conductive | conductive | conductive | conductive |
| Side wall rubber | | Con- | Non- | Non- | Non- | Non- | Non- | Non- | Non- | Non- | Non- | Non- |
| | | ductive | conductive | conductive | conductive | conductive | conductive | conductive | conductive | conductive | conductive | conductive |
| Topping rubber of | | Con- | Non- | Non- | Non- | Non- | Non- | Non- | Non- | Non- | Non- | Non- |
| carcass ply | | ductive | conductive | conductive | conductive | conductive | conductive | conductive | conductive | conductive | conductive | conductive |
| Rubber hardness | | 50 | 50 | 55 | 55 | 55 | 59 | 59 | 59 | 59 | 59 | 59 |
| of side wall | | | | | | | | | | | | |
| rubber (degree) | | | | | | | | | | | | |
| Side | With or | Without | Without | With | With | With | With | With | With | With | With | With |
| con- | without | | | | | | | | | | | |
| duc- | Rubber | — | — | 58 | 58 | 58 | 55 | 55 | 57 | 55 | 55 | 55 |
| tive | hardness | | | | | | | | | | | |
| layer | (degrees) | | | | | | | | | | | |
| | L14/TH | — | — | 36 | 36 | 60 | 30 | 43 | 36 | 30 | 30 | 55 |
| | (%) | | | | | | | | | | | |
| | H4o/TH | — | — | 54 | 47 | 54 | 54 | 54 | 54 | 54 | 54 | 54 |
| | (%) | | | | | | | | | | | |

TABLE 2

| | Com- | Com- | Com- | Com- | Com- | | | | | | |
|---|---|---|---|---|---|---|---|---|---|---|---|
| | parative | parative | parative | parative | parative | Working | Working | Working | Working | Working | Working |
| | Example 1 | Example 2 | Example 3 | Example 4 | Example 5 | Example 1 | Example 2 | Example 3 | Example 4 | Example 5 | Example 6 |
| Electric | 3 | ∞ | 3 | 3 | 3 | 3 | 3 | 3 | 3 | 3 | 3 |
| resistance (MΩ) | | | | | | | | | | | |
| Rolling | 100 | 110 | 109 | 109 | 107 | 109 | 109 | 109 | 109 | 102 | 109 |
| resistance | | | | | | | | | | | |
| Steering | 100 | 100 | 101 | 99 | 101 | 103 | 105 | 108 | 103 | 103 | 108 |
| stability | | | | | | | | | | | |
| performance | | | | | | | | | | | |
| Ride comfort | 100 | 100 | 100 | 102 | 100 | 105 | 103 | 105 | 105 | 105 | 101 |
| performance | | | | | | | | | | | |

As shown in Table 2, the comparative examples 1 and 2 do not have the conductive performance, and the comparative examples 3 to 5 have the conductive performance, however, are not improved in the steering stability performance and the ride comfort performance. On the contrary, in the working examples 1 to 6, a good steering stability performance and a good ride comfort performance can be achieved while having the conductive performance.

What is claimed is:

1. A pneumatic tire comprising:
a carcass reaching a bead portion via a side wall portion from a tread portion;
a tread rubber provided in an outer side of the carcass ply in the tread portion;
a side wall rubber provided in an outer side of the carcass ply in the side wall portion; and
a rim strip rubber provided in the outer side of the carcass ply in the bead portion and being contactable with a rim, wherein
a topping rubber of the carcass ply and the side wall rubber are formed by a non-conductive rubber, and the rim strip rubber is formed by a conductive rubber,
a height of an outer end of the rim strip rubber arranged in the outer side of the carcass ply is equal to or more than 50% of a tire cross section height based on a bead base line,
JIS A hardness of the side wall rubber is equal to or more than 59 degrees,
a side conductive layer having a smaller thickness than the side wall rubber and formed by the conductive rubber is provided between the side wall rubber and the carcass ply, an outer end of the side conductive layer is connected to the tread rubber, and an inner end of the side conductive layer is connected to the rim strip rubber, and
a conductive route reaching the outer end of the side conductive layer from a ground-contacting surface is constructed in the tread rubber.

2. The pneumatic tire according to claim 1, wherein a portion constructing at least the ground-contacting surface is formed by the non-conductive rubber, and a tread conductive layer continuously extending from one end exposed to the ground-contacting surface to the other end reaching the outer end of the side conductive layer and formed by the conductive rubber is embedded, in the tread rubber.

3. The pneumatic tire according to claim 1, wherein a length in a tire diametrical direction from the outer end of the side conductive layer to the inner end is in a range between 30 and 55% of the tire cross section height.

4. The pneumatic tire according to claim 1, wherein a height of the inner end of the side conductive layer is equal to or more than 55% of the tire cross section height based on the bead base line.

5. The pneumatic tire according to claim 1, wherein the side conductive layer is formed by a conductive rubber which is extruded together with the side wall rubber.

6. The pneumatic tire according to claim 1, wherein the side conductive layer is formed by a rubber tape which is an independent member from the side wall rubber.

7. The pneumatic tire according to claim 3, wherein a height of the inner end of the side conductive layer is equal to or more than 55% of the tire cross section height based on the bead base line.
